(19) United States
(12) Patent Application Publication
(10) Pub. No.: US 2006/0071957 A1
(43) Pub. Date: Apr. 6, 2006

(54) Droplet visualization of inkjetting

(75) Inventors: Quanyuan Shang, Saratoga, CA (US); Stephen F. McPherson, Menlo Park, CA (US)

Correspondence Address: PATTERSON & SHERIDAN, LLP, 3040 POST OAK BOULEVARD, SUITE 1500, HOUSTON, TX, 77056, US

(73) Assignee: APPLIED MATERIALS, INC.

(21) Appl. No.: 11/123,502

(22) Filed: May 4, 2005

Related U.S. Application Data
(60) Provisional application No. 60/616,253, filed on Oct. 5, 2004.

(51) Int. Cl. B41J 2/09

(52) U.S. Cl. 347/6

(57) ABSTRACT

The embodiments of the present invention describe an apparatus and a method of visualizing droplets dispensed from an inkjet printing system. A droplet visualization system is integrated with the inkjet printing system and is capable of measuring the sizes and the speeds of dispensed inkjet droplets and capturing the trajectories of the dispensed inkjet droplets. The measured information regarding the sizes, the speeds and trajectories of the droplets is feedback to the inkjet printing system to monitor and to control the dispense operation of the inkjet printing system. Due to this feedback control, the uniformities of the sizes, the speeds and the trajectories can be monitored and be improved.

### CROSS-REFERENCE TO RELATED APPLICATIONS

This application claims benefit of U.S. provisional patent application Ser. No. 60/616,253, filed Oct. 5, 2004, which is herein incorporated by reference.

### BACKGROUND OF THE INVENTION

1. Field of the Invention

Embodiments of the invention generally relate to droplet visualization and particularly to an apparatus and a method for droplet visualization of inkjetting in forming electronic devices such as color filters devices for flat panel displays.

2. Description of the Related Art

Flat panel displays (FPDs) have become the display technology of choice for computer terminals, visual entertainment systems, and personal electronic devices such as cellular phones, personal digital assistants (PDAs), and the like. Liquid crystal displays (LCDs), and especially active matrix liquid crystal displays (AMLCDs), have emerged as the most versatile and robust of the commercially available FPDs. A basic element of the LCD technology is a color filter through which light is directed to produce a colored visual output. The color filter is made up of pixels, which are typically red, green, and blue and are distributed in a pattern or array within an opaque (black) matrix which allows for improved resolution of the color filtered light.

Traditional methods of producing these color filters, such as dyeing, lithography, pigment dispersion, and electrodeposition, all have a major disadvantage of requiring the sequential introduction of the three colors. That is, a first set of pixels having one color is produced by a series of steps, whereupon the process must be repeated twice more to apply all three colors. A possible area for improvement in the technology applicable to color filter production has been the introduction of improved dispensing devices, such as inkjets. By using an inkjet system, all three colors can be applied within the color filter matrix in one step and hence the process need not be carried out in triplicate.

One challenge arising in utilization of inkjet technology is the dispensing of the color agent formulation into a pixel consistently and precisely. For mass productions of color filters and other devices by inkjetting, the inkjetting process must be performed accurately and precisely to ensure the quality of the product. Therefore, a need exists to develop an improved apparatus and method for verifying and improving the consistency and preciseness of dispensed inkjet droplets.

### SUMMARY OF THE INVENTION

The embodiments of the present invention provide an apparatus and a method for visualizing dispensed inkjet droplets to verify and to improve the consistency of dispensing inkjet droplets. In one embodiment, an apparatus for visualizing droplets of an inkjet printing system comprises a visualization device, a laser light source, a system controller, an image analyzer, and a processor.

In another embodiment, an apparatus for controlling the sizes, speeds and trajectories of dispensed droplets from an inkjet printing system comprises an inkjet printing system, and a integrated droplet visualization module that measures the sizes and speeds of the dispensed droplets, captures the trajectories of the dispensed droplets, and sends controlling signals to the inkjet printing system based on the data of measured sizes and speeds and captured trajectories of the dispensed droplets.

In another embodiment, a method for improving uniformities of inkjet droplet sizes and speeds comprises using an integrated droplet visualization module to collect data of the sizes and the speeds of the dispensed droplets, and to controll an inkjet printing system by the collected data of the sizes, the speeds, and the trajectories of the dispensed droplets.

In another embodiment, a method for measuring speed of an inkjet droplet dispensed from an inkjet printing system comprises turning on a visualization device of a droplet visualization module that is integrated with the inkjet printing system, pulsing on a laser light source mounted across the visualization device for a first period after a first time lapse from the moment the inkjet droplet is dispensed from an inkjet printing system for the visualization device to take first image of a dispensed droplet in a camera frame, pulsing on the laser light source for a second period after a second time lapse from the moment the inkjet droplet is dispensed from an inkjet printing system for the visualization device to take second image of the dispensed droplet in the same camera frame, calculating the distance the droplet traveled from the distance between the two droplet images on the same camera frame, and calculating the speed of the dispensed inkjet droplet by dividing the distance the droplet traveled to the duration between the first and second time lapses.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of an exemplary embodiment of an inkjet printing apparatus.

FIG. 2 is a side-view of the exemplary embodiment of the inkjet printing apparatus in FIG. 1.

FIG. 3 is a block diagram showing one embodiment of the apparatus of the claimed invention.

FIG. 4 is a diagram showing the relative positions of the camera, the droplet and the pulsed laser light.

FIG. 5 shows an exemplary time sequence of visualization of a droplet.

FIG. 6 shows a schematic drawing of a camera frame with images of droplet 290 taken at first laser pulse and at second laser pulse.

### DETAILED DESCRIPTION OF THE PREFERRED EMBODIMENT

To dispense the color agent formulation into a pixel consistently and precisely, the inkjet droplet size, droplet speed and droplet trajectory need to be consistent and precise throughout the dispensing process. The embodiments of the invention describe an apparatus and a method to visualize the sizes, the speeds (or velocities), and trajectories of inkjet droplets during the droplets dispensing process. The embodiments of the invention further describe an apparatus and a method to improve the consistency of the sizes, the velocities and trajectories of inkjet droplets during the droplet dispensing process.

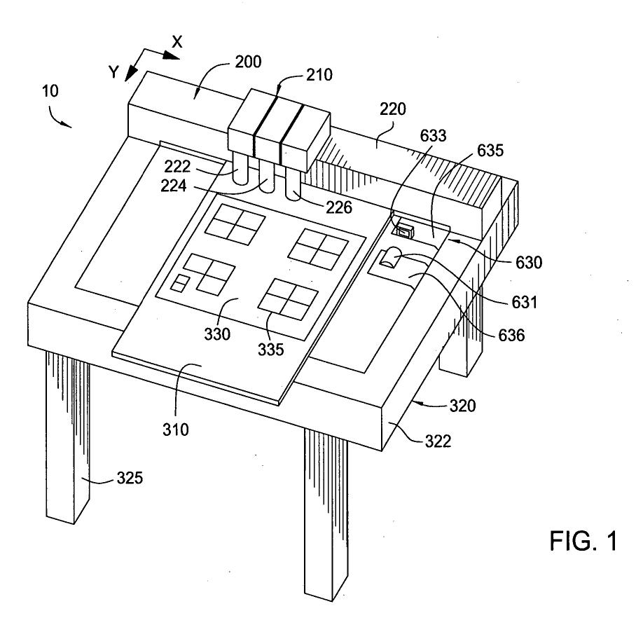

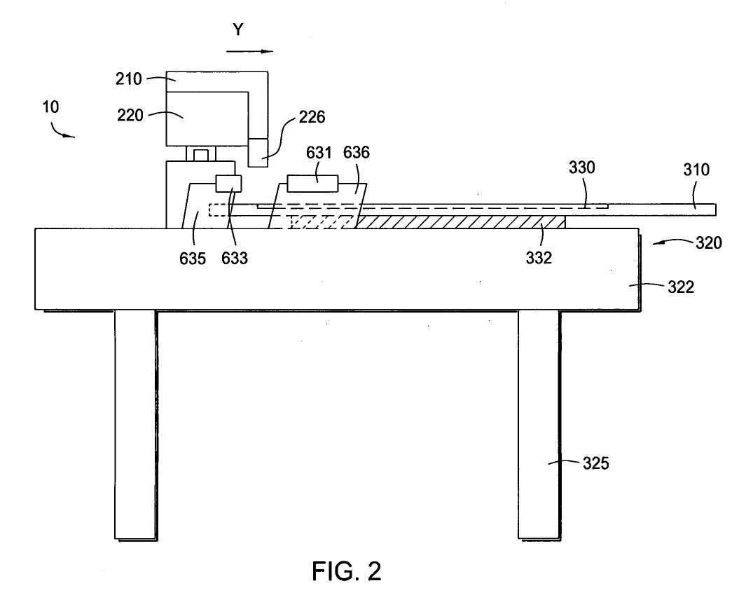

FIG. 1 is a perspective view of an exemplary embodiment of an inkjetting apparatus 10 to form color filters in flat panel displays of the present invention. FIG. 1 illustrates components of a stage positioning system 320 which includes a stage 310. In the embodiment shown in FIG. 1, the stage 310 moves in the Y direction and the inkjet heads 222, 224, and 226 of an inkjet printing module 210 move in the X direction. In other embodiments, the stage 310 could move in both X and Y directions. A stage moving device 332 (shown in FIG. 2) with one or more motors could be used to move the stage 310 in the Y-axis direction. In an exemplary embodiment, the substrate stage 310 can also be rotatable by using an appropriate stage rotating device (not shown). The stage 310 can also be rotated so as to rotate and/or orient the substrate 330 for aligning the substrate 330 and the display object(s) contained thereon with an inkjet printing module 210 of a inkjet printing system 200.

The stage 310 can be of any appropriate or suitable size to support a substrate or substrates which are to be processed. In an exemplary embodiment, the apparatus 10 and its component parts can, for example, process substrates having dimensions of, for example, 5500 cm² and above. The apparatus 10 and its component parts can be designed and adapted to process substrates having any size.

With reference once again to FIG. 1, the processing apparatus 10 also include a stage positioning system 320 which supports the substrate stage 310 and which, in an exemplary embodiment, can include a top portion 322 and a plurality of legs 325. Each leg may include an air cylinder or other cushioning mechanism (not shown) to isolate the stage 310 from vibrations (e.g., from the floor on which the processing apparatus 10 rests). The stage positioning system 320 can also include a controller (not shown) for controlling the operation of the stage moving device (not shown). The substrate 330 shown in FIG. 1 can include any number of display objects 335.

FIG. 1 illustrates an inkjet printing module 210 of the inkjet printing system 200 and an inkjet printing module support 220 on which the inkjet printing module 210 is mounted. In an exemplary embodiment, the inkjet printing module 210 is moveable along the inkjet printing module support 220 by an inkjet positioning device (not shown). In the embodiment of FIG. 1, the inkjet printing module 210 includes three, or more, inkjet devices 222, 224 and 226. In an exemplary embodiment, each inkjet device 222, 224 and 226 can dispense a different color ink, for example red, green, blue, and optionally a clear ink, depending upon the color system being utilized. For example, a first inkjet device can dispense Red ink, a second inkjet device can dispense Green ink and a third inkjet device can dispense Blue ink. In another exemplary embodiment, any one or more of the inkjet devices can dispense a same color ink or a clear ink. Although described as being equipped with three inkjets devices, the inkjet printing module 210 and the apparatus 10 of the present invention can utilize any number of inkjet devices depending upon the application or use of the apparatus 10.

In one embodiment of the invention, each of the inkjet devices 222, 224 and 226 can move independently of each other while printing. This may be advantageous when printing more than one panel on a substrate. Each of the inkjet devices 222, 224 and 226 can include an inkjet head (not shown), an isolated head interface board (not shown), a height adjustment device (not shown), a head rotation actuator device (not shown), and an ink reservoir (not shown). For example, each of the inkjet head, can be rotated by its respective head rotation actuator device. In this manner, the pitch or the angle at which an inkjet head is oriented relative to a display object on a substrate can be changed depending upon a printing application. Each inkjet head can have numerous nozzles, for examples 128 nozzles. The droplets are dispensed at frequencies between about 0.01 KHz to about 100 KHz. The sizes of the droplets are between about 2 μm to about 100 μm in diameters. The speeds of the droplets are between about 2 m/s to about 12 m/s. In one embodiment, each of the inkjet heads, or any other inkjet heads described as being utilized in the apparatus 10, can be a Spectra SE128A, SX128, or SM128 inkjet head assembly. The Spectra SE-128 inkjet head assembly has 128 nozzles, with each nozzle having a diameter of 38 microns and a space between adjacent nozzles of 508 microns. The Spectra SE-128 inkjet head assembly can dispense ink droplets having a volume of approximately 25 to 35 Pico liters and can operate at a frequency of approximately 40 KHz.

A droplet visualization system 630 is also illustrated in FIG. 1. The droplet visualization system 630 includes a droplet visualization device 633 that takes images of droplets dispensed from the inkjet devices, a pulsed light 631 that flashes at a controlled frequency for a controlled duration, an image analyzer (described below), a processor (described below), and a visualization system controller (described below). In one embodiment, the drop droplet visualization device 633 and the pulsed light 631 are placed near the edge of the top portion 322 of the stage positioning system 320. Before the inkjet devices, 222, 224, and 226, dispense droplets on the substrate 330, they first dispense droplets in a “gutter” between the visualization device 633 and the pulse light 631 to verify the sizes, the speeds and the trajectories of the droplets. This process is called the inkjet droplet verification process. The dispensed droplets during this verification process are contained by a collection plate (not shown), placed between and below the visualization device 633 and the pulse light 631. After the sizes, the speeds and the trajectories of the droplets are verified to be within the process specification, the inkjet devices, 222, 224, and 226, are then allowed to dispense droplets on the substrate 330. If the sizes, the speeds, and the trajectories of the dispensed droplets are found to be out of the process specification during the verification process, the inkjet devices, 222, 224, and 226, are adjusted until the sizes, the speed, and the trajectories are within specification.

In one embodiment, the visualization device 633 is a charge coupled device (CCD) camera. Since the droplet size is quite small, about 2 μm to about 100 μm in diameters, a telescope zoom lens is required. The visualization device 633 should have high resolution as well to increase the resolution of droplet detection, for example at least 1024×768 pixels. The camera can also be equipped with a motorized zoom and focus device (not shown). Other camera types and/or resolutions may also be used. In one embodiment, the camera 633 is mounted on a structure 635, which is coupled to the inkjet printing module support 220. The structure 635 can also be coupled to the inkjet printing module support 220. In one embodiment the position, including height and the mounted angle, of the visualization device 633 can be adjusted to align with the trajectories of the dispensed droplets. In another embodiment, the visualization device 633, also include a microscope (not shown), which the camera can be attached to the viewfinder of the microscope so to record images obtained at the viewfinder of the microscope. The field of view of the camera 633 should be between about 0.1 mm to about 5 mm, and the field of depth of the camera 633 should be between about 0.05 mm to about 5 mm to take images of droplets, whose sizes are between about 2 μm to about 100 μm in diameters.

The light 631 could to be a nanosecond pulsed laser to illuminate the continuously generated flying droplets. Laser light is chosen to the preferred light source due to its faster and more accurate on/off control and also due to its finite directionality. Fast and accurate on/off control of the light source is important in this application and the finite directionality of the laser beams would make the images of the droplets more clear. A relatively high power pulsed laser is required in order to ensure sufficient image intensity to be achieved within short illumination pulse. In one embodiment, the power of the laser light is between about 0.001 mW to about 20 mW. In one embodiment, two images of a droplet are taken in one image frame to calculate the speed of the droplets by firing the laser pulse twice with a controlled interval so that the droplet has not traveled outside the field of view. The distance between the two images can be used to measure the distance the droplet traveled during the time between the two pulses are taken. For a droplet traveling at a speed between about 8 m/s to be captured on a camera with a field of view between about 0.1 mm to about 5 mm, the laser light 631 need to be pulsed at less than 200 microseconds time interval. In one embodiment, the laser light 631 is mounted on a structure 636. The distance between the visualization device 633 and the laser light 631 can be adjusted by moving either the structure 635 or structure 636.

FIG. 2 is a side view of the processing apparatus 10 of FIG. 1. FIG. 2 illustrates the inkjet printing module 210, including one the three inkjet devices 226 (inkjet devices 222 and 224 are behind 226), the inkjet printing module support 220, the stage 310, the base frame structure 320 and the top portion 322 and two of the legs 325 of the base frame structure 320. The substrate 330 sits on the stage 310, which is support by a stage moving device 332. The visualization device, or camera, 633, of the droplet visualization system 630, is mounted on the structure 635 and the laser light 631 is mounted on structure 636.

During the inkjetting process, the substrate 330 is moved in the Y-axis direction beneath the inkjet devices 222, 224, and 226. Once the targeted position in the Y-axis is reached, the inkjet head devices 222, 224, and 226 moves along the X-axis on the inkjet printing module support 220 to perform the ink deposition operation by depositing ink drops at ink drop positions or locations on the substrate 330. For example, the speed at which the stage 310 and hence the substrate 330 is moved can be from approximately 500 mm/sec to approximately 1000 mm/sec. Other speed/speed ranges may be used.

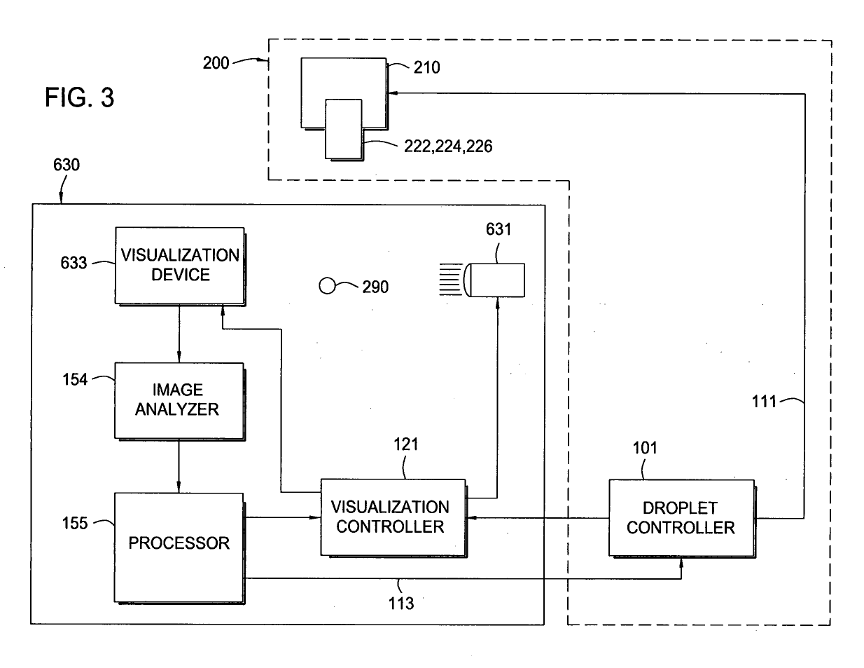

During the process, the inkjet head devices 222, 224, and 226 dispense inkjet droplets through the nozzles. In one embodiment, when the inkjet printing module 210 passes the droplet visualization system 630, it triggers the control system (not shown) of the droplet visualization system 630. FIG. 3 shows a block diagram of a control system 150 for the inkjet printing system 200 and inkjet droplet visualization system 630. The droplet visualization system 630 comprises the visualization system controller 121, a camera (or a visualization device) 633, a laser light 631, an image analyzer 154, a processor 155, visualization software (not shown), and control software (not shown). The image analyzer 154 and the processor 155 can be integrated into one. The inkjet printing system 200 comprises inkjet printing module 210, which includes inkjet head devices 222, 224, and 226, and a droplet controller 101. The control system 150 comprises the image analyzer 154, the processor 155, the visualization controller 121, the droplet controller 101 and associated software.

The inkjet processing system comprises an inkjet firing devices 222, 224, and 226, and a droplet controller 101. The droplet controller 101 sends inkjet droplet firing signals to the inkjet firing devices 222, 224, and 226 via a control bus 111. The inkjetting operation can be controlled by the droplet controller 101. The droplet controller 101 uses information obtained from processor 155 of the droplet visualization system 630 via a control bus 113 and stored substrate image data file (not shown) to control the ink printing module 210. The substrate image data file can be generated for, and can contain information for, any given substrate which can be processed in the apparatus 10 of the present invention. The droplet controller 101 can control an ink dispensing or a nozzle “jetting” or “firing” by controlling the inkjet printing module 210, by controlling any of the inkjet devices 222, 224, 226, etc. For example, the herein described inkjet devices can perform a nozzle “jetting” or “firing” operation, thereby dispensing an ink droplet from the same nozzle approximately every 25 micro-seconds. A 0.0125 mm resolution can be achieved on a substrate for an ink deposition operation if the stage 310 can be moved at a speed of 500 mm/sec. Other jetting frequencies and/or resolutions may be employed.

The droplet controller 101 also sends droplet firing signal and inkjet head position signal to a visualization system controller 121 of the visualization system 630 via a control bus 112. The visualization controller 121, using the droplet firing signal inkjet head position signals, controls the pulses of the laser light 631 and also the on and off of the visualization device 633. The camera 633 captures images of a droplet 290 that is within the field of view (FOV) when the laser light 631 is turned on. In one embodiment, the visualization system 633 uses a nanosecond pulsed laser to illuminate the continuously generated flying droplets. A high power pulsed laser is required in order to ensure sufficient image intensity to be achieved within short illumination pulse.

The visualization system 630 could utilize camera with a high resolution, for example at least 1024×768 pixels to view a field of view, for example 2 mm. This will produce a pixel resolution of 2 μm per pixel. A round drop with a diameter example 25 μm will have a diameter of approximately 12.5 pixels. A 1% variation in drop diameter will result in a change in each edge position of about ⅛ pixel. This amount of variation in droplet size will be detectable by visualization software, such as the Cognex Vision Pro software. The camera 633, such as a ⅔″ charge coupled device (CCD) camera, is linked to an image analyzer 154, which also stores the visualization software. The camera is kept at a working distance, such as 90mm or above, from the laser light source 631. The droplets, such as droplet 290, fall at a distance of depth of field, for example 0.12 mm, from the camera 633. The depth of field can be extended with the iris if enough light is available. Generally speaking, increasing the working distance will increase the DOF, and decreasing the iris (amount of light reaching the lens) will also increase the DOF. The laser light must provide accurate and good illumination of for the droplets.

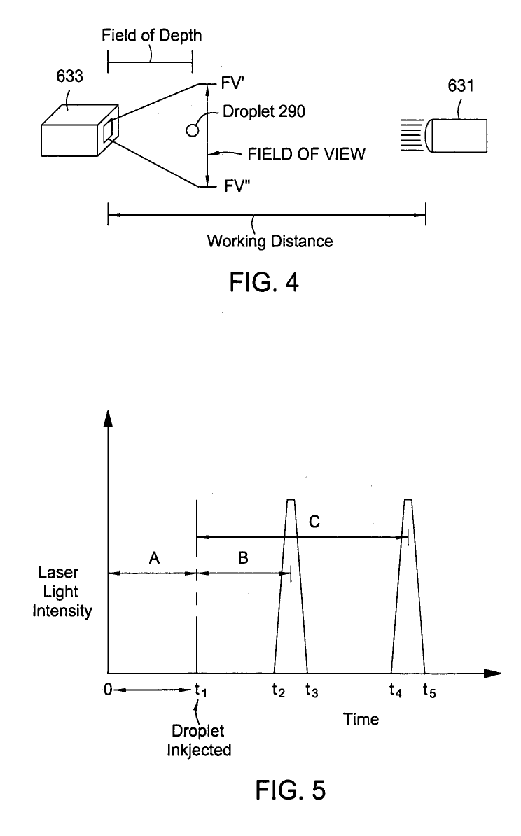

FIG. 4 shows the distance relationship between the camera lens, a droplet 290, and the laser light 631. The distance between the camera and the light source is working distance. The distance between the droplet and the camera is field of depth. The field of view is the range of the object that the camera can capture. Field of view is dependent on the field of depth. The farther the field of depth, the larger the field of view will be.

To calculate the speed of a droplet, double exposures of the same droplet 290 could be taken to measure the distance the droplet traveled during the time lapse between the two exposures. The distance the droplet traveled is proportional to and can be calculated from the distance between the two droplet images on the picture taken. The speed of the droplet can be calculated by dividing the distance between the two exposures by the time lapse between the two exposures. FIG. 5 shows the time relationship between the inkjet print module 210, the camera 633, the droplet 290 and the laser light 631. At time 0, inkjet print module 210 travels close to the visualization system 630 and trigger the visualization system 630. At t₁, or after duration “A” from the triggering signal, the droplet 290 is “fired” (or dispensed) from one of the inkjet devices, 222, 224, or 226. At t₂, the laser light is turned on and at t₃ the laser light is turned off. During the period between t₂ to t₃, which occurs after time lapse “B” from the time the droplet 290 is “fired” (or dispensed), the image of the droplet 290, which is near the top of the field of view of the camera 633, is taken. At t₄ the laser light is turned on again and at t₅ the laser light is turned off again. During the period between t₄ to t₅, or after time lapse “C” from the time the droplet 290 is “fired”, second image of the droplet 290, which by now is near the bottom of the field of view of the camera 633, is taken. Multiple drops could be present in the field of view when the inkjet droplets are fired at higher rates, such as above 8 KHz. In one embodiment, the on/off durations, t₂ to t₃, and t₄ to t₅, are less than 100 nanoseconds, and preferably 1000 nanoseconds or less.

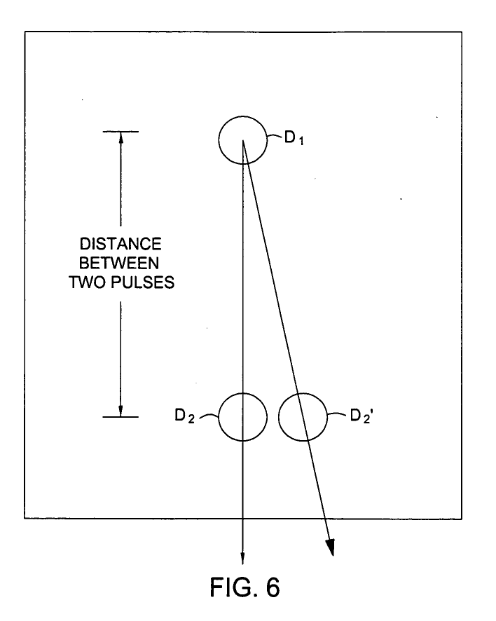

FIG. 6 shows a schematic drawing of “D₁” of droplet 290, captured at the first laser pulse (between t₂ to t₃), and “D₂” of droplet 290, captured at the second laser pulse (between t₄ to t₅). The droplet 290 could also be captured as “D₂” at the second laser pulse, if the droplet is not fired vertically downward. The speed of droplet 290 can be calculated by dividing the distance between two pulses over the time lapse between the two laser pulse (or C-B).

The system should control the durations “A”, “B” and “C” to prevent images of more than one droplet are captured in one frame. For example, when a camera has a field of view of 2 mm and the droplet 290 is traveling at a speed of 8 m/s, the time lapse between the two exposures, “C” minus “B”, should be no greater than 25 μs, according to equation (1).
Time lapse between the two exposures≦(field of view)/(droplet speed) (1)

Since the droplet speed is typically between about 2 m/s to about 12 m/s, and the field of view is between about 0.1 mm to about 5 mm, the time lapse between the two exposures, C-B, should be kept between 5 μs to about 2500 μs.

The periods when the laser light is on, between t₂ to t₃ and between t₄ to t₅, should be kept short to ensure clarity of the droplet images. For a droplet traveling at 8 m/s, the droplet would travel 0.2 μm for a 25 ns pulse width, which is the time between t₂ to t₃ or the time between t₄ to t₅. As mentioned earlier, for a high resolution camera with 1024×768 pixels for a field of view, for example 2 mm, a pixel resolution is 2 μm per pixel. The 0.2 μm blur due to motion in the image is significantly less than the pixel size. The pulse width should be kept short to ensure the droplet travels less than 10% of the pixel size.
Pulse width<(10% pixel resolution)/(droplet speed) (2)

When the droplet speed is between about 2 m/s to about 12 m/s and the pixel resolution is 2 μm per pixel, the pulse width, should be below about 15 ns to about 2500 ns, depending on the droplet speed and according to equation (2). In one embodiment, the pulse width, or on/off duration, t₂ to t₃, or t₄ to t₅, is less than 1000 nanoseconds, and preferably 100 nanoseconds or less.

Achieve precise control of pulse width and on-off control of the laser light, a nanosecond laser light that can be accurately controlled is preferred. In addition, the laser light must provide sufficient illumination to allow images of the droplets to be taken; therefore, the pulse width cannot be too short either.

Depending on how many droplets or how often the system wants to monitor the dispensed droplets, the camera image frame frequency can be adjusted. In one embodiment, the frame frequency of the camera 633 is 30 Hz. However cameras with higher frame frequencies can also be used. The droplet size can be calculated based on the area of the droplet. This size can be converted to a diameter measurement. In addition, trajectory of the droplet can be captured by the camera, as shown in FIG. 6. Using image analysis tool, the drop size, speed and location can be measured to 1% precision. The available systems in the market can not achieve the accuracy (+3%) of embodiments of the present invention.

The invention uses very narrow pulsed laser (up to nanoseconds in width) in duration to illuminate the flying drop. The drop captured thus has minimum blur or image distortion so that its size can be determined more accurately to ≦+1%. In addition, the measurement process using this technique is drop by drop and not an average value. Therefore, drop statistical information can be obtained and used to control the drop size, and make the uniform performance or other performance attributes (e.g., improve the drop quality). The drop information is feedback to inkjet drop generator electronics to control the drop size the speed of drops from the nozzles. The instant feedback mechanism allows the system to improve the droplet size and speed uniformity as a function of time, and therefore improves the uniform of color filter the system manufactures.

Although the droplet visualization device 633 and the pulsed light 631 are described to be placed near the edge of the top portion 322 of the stage positioning system 320 to allow verifying and controlling the sizes, the speeds, and the trajectories of the dispensed droplets before the droplets are dispensed on the substrate 330. The droplet visualization device 633 and the pulsed light 631 can also be placed at other locations to allow droplet visualization during inkjetting on substrate 330.

While the foregoing is directed to embodiments of the present invention, other and further embodiments of the invention may be devised without departing from the basic scope thereof, and the scope thereof is determined by the claims that follow.

1. An apparatus for visualizing inkjet droplets of an inkjet printing system, comprising:
a visualization device; and
a laser light source, wherein the laser light source is positioned to direct a laser between one or more inkjet device that can dispense inkjet droplets of the inkjet printing system and a substrate receiving surface of a substrate support of the inkjet printing system

2. The apparatus of claim 1, wherein the visualization device is a high resolution charge coupled device camera.

3. The apparatus of claim 1, wherein the laser light is a nanosecond pulsed laser.

4. The apparatus of claim 3, wherein the power of the laser light source is between about 0.001 mW to about 20 mW.

5. The apparatus of claim 1, wherein the apparatus for visualizing the inkjet droplets measure the sizes and speeds of the inkjet droplets and captures the trajectories of inkjet droplets.

6. (canceled)

7. An apparatus for controlling the sizes, speeds and trajectories of dispensed inkjet droplets from an inkjet printing system, comprising:
an inkjet printing system;
a substrate support having a substrate receiving surface; and
a integrated inkjet droplet visualization module that measures the sizes and speeds of the dispensed inkjet droplets, captures the trajectories of the dispensed inkjet droplets, and sends controlling signals to the inkjet printing system based on the data of measured sizes and speeds and captured trajectories of the dispensed inkjet droplets.

8. The apparatus of claim 7, wherein the inkjet printing system comprises:
an inkjet printing module; and
an inkjet droplet controller that controls the inkjet printing module based on the information of measured sizes and speeds, and captured trajectories of the dispensed inkjet droplets; wherein the information is collected by the integrated inkjet droplet visualization system.

9. The apparatus of claim 8, wherein the inkjet printing module comprises one or more inkjet devices that can dispense one or more color ink.

10. The apparatus of claim 7, wherein the droplet visualization module comprises:
a visualization device:
a laser light source;
a visualization system controller which controls the laser light source and the visualization device;
an image analyzer; and a processor.

11. The apparatus of claim 10, wherein the visualization device is a high resolution charge coupled device camera.

12. The apparatus of claim 10, wherein the laser light is a nanosecond pulsed laser.

13. (canceled)

14. A method for improving uniformities of inkjet droplet sizes and speeds, comprising:
using an integrated inkjet droplet visualization module to collect information of the sizes speeds and trajectories of the dispensed inkjet droplets from an inkjet printing system; and
controlling an inkjet printing system by the collected information of the sizes, the speeds, and the trajectories of the dispensed inkjet droplets.

15. The method of claim 14, wherein the sizes, the speeds, and the trajectories of dispensed inkjet droplets are collected by using a nanosecond laser light to take double exposures of at least one of the dispensed inkjet droplets when the at least one of the dispensed inkjet droplets travels in front of a visualization device to capture at least two images of the at least one of the dispensed inkjet droplets to determine the sizes, speed, and trajectory of the at least one of the dispensed inkjet droplets.

16. The method of claim 14, wherein the dispensed droplets travels at speeds between about 2 m/s to about 12 m/s.

17. The method of claim 14, wherein the sizes of the droplets are between about 2 μm to about 100 μm in diameters.

18. The method of claim 15, wherein the time lapse between the two exposures should be between about 5 μs to about 2500 μs.

19 The method of claim 15, wherein the exposure time is less than 1000 nanoseconds.

20.-25. (canceled)

26. The apparatus of claim 1, wherein the visualization device is positioned to receive light from the laser light source.

27. The apparatus of claim 1, wherein the laser light source is positioned to direct a laser at an inkjet droplet dispensed from the one or more nozzle as the inkjet droplet travels between the one or more nozzle and a substrate disposed on the substrate receiving surface.

28. The apparatus of claim 1, wherein the apparatus further comprises:
an image analyzer;
a visualization system controller which controls the visualization device and the laser light source; and
a processor, wherein the visual light source, the visualization device, the image analyzer, the visualization system controller, and the processor form a droplet visualization system, which measures the sizes and speeds of the inkjet droplets and captures the trajectories of the inkjet droplets.

29. The apparatus of claim 28, wherein the droplet visualization system determines the landing positions of the inkjet droplets upon substrates on the substrate receiving surface of the substrate support from the trajectories of inkjet droplets captured by the droplet visualization system.

30. The apparatus of claim 28, wherein the one ore more inkjet device of the inkjet printing system is controlled by a droplet controller that receives droplet information of sizes, speeds, trajectories, and landing positions from the droplet visualization system.

31. A method for visualizing inkjet droplets dispensed from an inkjet printing system comprising:
providing a first pulse of laser light source toward an inkjet droplet, dispensed from an inkjet printing system, at a first position;
recording a first image of the inkjet droplet, which is illuminated by the first pulse of laser light source, and the time of the first pulse of laser light source at the first position;
providing a second pulse of laser light source toward the inkjet droplet traveling from the first position to a second position; and
recording a second image of the inkjet droplet, which is illuminated by the second pulse of laser light source, and the time of the second pulse of the laser light at the second position.

32. The method of claim 31, further comprising:
determining the sizes of the inkjet droplet from the first and second images.

33. The method of claim 31, further comprising:
determining the speed of the of the inkjet droplet from the first and second images and from the recorded times of the first and second pulses of laser light source.

34. The method of claim 31, further comprising:
determining the trajectory of the inkjet droplet from the from the first and second images and from the recorded times of the first and second pulses of laser light source.

35. The method of claim 32, further comprising:
determining the landing position of the inkjet droplet from the from the first and second images and from the recorded times of the first and second pulses of laser light source.
